(19) United States
(12) Patent Application Publication
(10) Pub. No.: US 2022/0392201 A1
(43) Pub. Date: Dec. 8, 2022

(54) IMAGE FEATURE MATCHING METHOD AND RELATED APPARATUS, DEVICE AND STORAGE MEDIUM

(71) Applicant: Zhejiang SenseTime Technology Development Co., Ltd., Hangzhou (CN)

(72) Inventors: Xiaowei ZHOU, Hangzhou (CN); Hujun BAO, Hangzhou (CN); Jiaming SUN, Hangzhou (CN); Zehong SHEN, Hangzhou (CN); Yuang WANG, Hangzhou (CN)

(73) Assignee: Zhejiang SenseTime Technology Development Co., Ltd., Hangzhou (CN)

(21) Appl. No.: 17/820,883

(22) Filed: Aug. 19, 2022

Related U.S. Application Data
(63) Continuation of application No. PCT/CN2021/102080, filed on Jun. 24, 2021.

(30) Foreign Application Priority Data
Mar. 5, 2021 (CN) 202110247181.8

(51) Int. Cl. G06V 10/77; G06V 10/44

(52) U.S. Cl. CPC G06V 10/7715; G06V 10/443

(57) ABSTRACT

In an image feature matching method, at least two images to be matched are acquired; a feature representation of each image to be matched is obtained by performing feature extraction on the image to be matched, wherein the feature representation comprises a plurality of first local features; transforming the first local features into first transformation features having a global receptive field of the images to be matched; and a first matching result of the at least two images to be matched is obtained by matching first transformation features in the at least two images to be matched.

### CROSS-REFERENCE TO RELATED APPLICATIONS

This disclosure is a continuation of International Application No. PCT/CN2021/102080 filed on Jun. 24, 2021, which claims priority to Chinese patent application No. 202110247181.8 filed on Mar. 5, 2021. The disclosures of the above-referenced applications are hereby incorporated by reference in their entirety.

### BACKGROUND

Image matching is the basic problem in computer vision, and the accuracy of image matching will affect the operation after image matching. A common image matching way mainly includes the following three steps that first, feature detection is performed, that is, whether an image contains a key point (also referred to as a feature point) is determined; second, the detected key point and a descriptor of the key point are extracted; and third, feature matching is performed according to the extracted feature. This way only uses the descriptor of the key point for feature matching. Since the descriptor of the key point only represents the relationship between a plurality of pixel points around the key point, that is, representing local information around the key point, in the case where an image lacks texture, etc., the descriptor cannot well represent the information about the key point, so that final feature matching fails.

### SUMMARY

The disclosure relates to the technical field of image processing, in particular to an image feature matching method, an electronic device, and a storage medium.

Embodiments of the present disclosure at least provide an image feature matching method and related apparatus, a device, and a storage medium.

A first aspect of the embodiments of the present disclosure provides a method for image feature matching. The method includes: acquiring at least two images to be matched; obtaining a feature representation of each image to be matched by performing feature extraction on the image to be matched, herein the feature representation includes a plurality of first local features; transforming the first local features into first transformation features having a global receptive field of the images to be matched; and obtaining a first matching result of the at least two images to be matched by matching first transformation features in the at least two images to be matched.

A third aspect of the embodiments of the disclosure provides an electronic device, which may include a memory and a processor. The processor is configured to execute a program instruction stored in the memory to implement the method for image feature matching in the first aspect.

A fourth aspect of the embodiments of the disclosure provides a computer readable storage medium having stored thereon a program instruction which, when executed by a processor, implements the method for image feature matching in the first aspect.

It is to be understood that the above general descriptions and the following detailed descriptions are only exemplary and explanatory, and do not limit the disclosure.

### BRIEF DESCRIPTION OF THE DRAWINGS

The drawings herein are incorporated into and constitute a part of the specification. These drawings illustrate embodiments in accordance with the disclosure and are used together with the specification to explain the technical solutions of the disclosure.

FIG. 1A is a first schematic diagram of an application scenario of a terminal device according to an embodiment of the disclosure.

FIG. 1B is a second schematic diagram of a method application scenario of a terminal device according to an embodiment of the disclosure.

FIG. 2 is a first flowchart of an embodiment of an image feature matching method according to the disclosure.

FIG. 3 is a schematic diagram of a second matching result as shown in an embodiment of an image feature matching method according to the disclosure.

FIG. 4 is a second flowchart of an embodiment of an image feature matching method according to the disclosure.

FIG. 5 is a third flowchart of an embodiment of an image feature matching method according to the disclosure.

FIG. 6A is a schematic diagram of an exemplary indoor image feature matching result according to an embodiment of the disclosure.

FIG. 6B is a schematic diagram of an exemplary outdoor image feature matching result according to an embodiment of the disclosure.

FIG. 7 is a structural schematic diagram of an embodiment of an image feature matching apparatus according to the disclosure.

FIG. 8 is a structural schematic diagram of an embodiment of an electronic device according to the disclosure.

FIG. 9 is a structural schematic diagram of an embodiment of a computer readable storage medium according to the disclosure.

### DETAILED DESCRIPTION

Solutions of the embodiments of the present disclosure will now be described in detail in combination with the accompanying drawings.

In the following descriptions, specific details such as a specific system structure, an interface, and a technology are set forth for purposes of illustration rather than limitation, so as to provide a thorough understanding of the disclosure.

The term “and/or” in this specification describes only an association relationship for describing associated objects and represents that three relationships may exist. For example, A and/or B may represent the following three cases: Only A exists, both A and B exist, and only B exists. In addition, character “/” in the disclosure usually represents that previous and next associated objects form an “or” relationship. Furthermore, “multiple” herein means two or more than two. In addition, the term “at least one” herein indicates any one of multiple kinds or any combination of at least two of the multiple kinds, for example, including at least one of A, B or C, which may indicate including any one or more elements selected from a set consisting of A, B and C.

An executive subject of the image feature matching method provided by the embodiments of the disclosure may be an image feature matching apparatus, for example, the image feature matching method may be executed by a terminal device or a server or other processing devices. Herein, the terminal device may be User Equipment (UE), mobile equipment, a user terminal, a terminal, a cellular phone, a cordless phone, Personal Digital Assistant (PDA), a handheld device, a computing device, a vehicle-mounted device, a wearable device as well as an autonomous vehicle, which have visual positioning, three-dimensional reconstruction, image registration and other requirements, a robot with positioning and mapping requirements, a medical imaging system with registration requirements, spectacles, helmets, and other products for augmented reality or virtual reality. In some possible implementation, the image feature matching method may be implemented in a manner that a processor calls a computer readable instruction stored in a memory.

Descriptions are made below to the exemplary application in which the executive subject of the image feature matching method is executed as a terminal device.

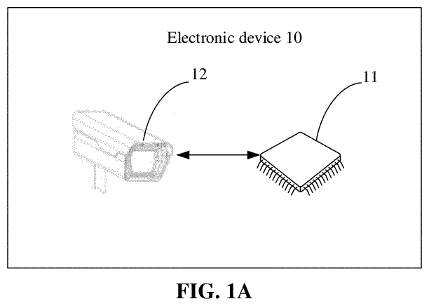

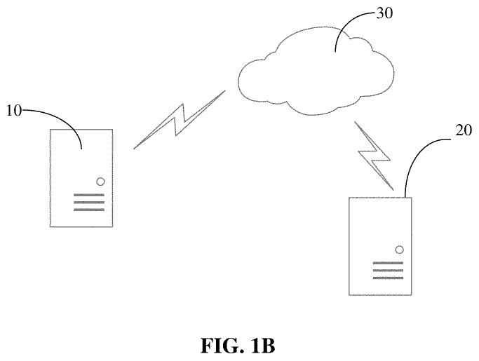

In an possible implementation, referring to a first schematic diagram of an application scenario of a terminal device illustrated in FIG. 1A, the terminal device 10 may include a processor 11 and a camera component 12, so that the terminal device 10 may collect at least two images to be matched via the camera component 12, and perform matching analysis processing on the at least two images to be matched via the processor 11 to obtain a matching result between the at least two images to be matched. For example, the terminal device may be implemented as a smartphone.

In another possible implementation, referring to a second schematic diagram of an application scenario of a terminal device shown in FIG. 1B, the terminal device 10 may receive at least two images to be matched transmitted by other devices 20 through a network 30. Thus, the terminal device 10 may perform matching analysis processing on the at least two received images to be matched to obtain a matching result between the at least two images to be matched. For example, the terminal device may be implemented as a computer, and the computer may receive at least two images to be matched transmitted by other devices through a network.

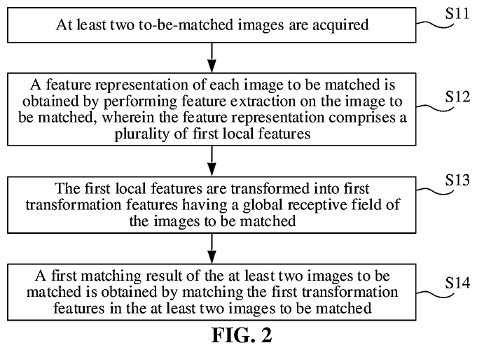

Referring to FIG. 2, FIG. 2 is a first flowchart of an embodiment of an image feature matching method according to the disclosure. Specifically, the image feature matching method may include the steps S11 to S14.

At S11, at least two images to be matched are acquired.

Herein, the manner of acquiring the image to be matched may be acquired by a camera component on a device executing the image feature matching method, such as the application scenario illustrated in FIG. 1A. The manner of acquiring the image to be matched may also be that the image to be matched is transmitted by other devices in various manners of communication manners to the device executing the image feature matching method, such as the application scenario illustrated in FIG. 1B. No limitations are made to the manner of acquiring the image to be matched in the embodiment of the disclosure.

Here, the image to be matched may be an image subjected to various image processing, and may be an image without image processing. Furthermore, the modalities of the images to be matched may be the same and may also be different. For example, one of the images is a visible light image, and another image is an infrared light image. The information such as the size and resolution of at least two images to be matched may be the same and may also be different. That is, any two images may be used as the images to be matched. The embodiment of the present disclosure takes two images to be matched as an example. Of course, in other embodiments, the images to be matched may be three or more images, and the number of the images to be matched is not specified herein.

At S12, a feature representation of each image to be matched is obtained by performing feature extraction on the image to be matched, the feature representation includes a plurality of first local features.

Herein, there may be various manners of feature extraction. For example, various neural networks may be used for feature extraction. The feature representation includes a plurality of first local features, and the feature representation may be presented in the form of a feature map. A local feature refers to a feature which does not include a global receptive field of a image to be matched, i.e., a feature which only includes a local region of the image to be matched.

At S13, the first local features are transformed into first transformation features having a global receptive field of the images to be matched.

The first local features are transformed, so that the first transformation feature after transformation can have a global receptive field of the image to be matched. That is, the first transformation feature has global information about the image to be matched.

At S14, a first matching result of the at least two images to be matched is obtained by matching the first transformation features in the at least two images to be matched is matched.

There may be multiple manners of feature matching, such as performing feature matching using an optimal transportation mode. Of course, this is only an example. In other embodiments, other feature matching manners may be used.

Through the above solution, the feature having the global receptive field in the image to be matched is acquired and then feature matching is performed using the feature having the global receptive field, so that the global information about the image to be matched can be considered in the feature matching process, thereby improving the matching accuracy.

Herein, the feature representation includes a first feature map and a second feature map, and the resolution of the first feature map is less than the resolution of the second feature map. The feature in the first feature map is a first local feature, and the feature in the second feature map is a second local feature. Herein, the manner of obtaining a feature representation of each image to be matched by performing feature extraction on the image to be matched may be obtaining by using a pyramid convolution neural network. Herein, the multi-scale feature map of the image to be matched may be acquired by using the pyramid convolution neural network. For example, a feature map with a resolution of one eighth of the resolution of the image to be matched and a feature map with a resolution of one half of the resolution of the image to be matched are extracted, or feature maps with a resolution of one sixteenth and one quarter of the resolution of the image to be matched respectively are extracted. In some embodiments, the resolution of the first feature map is a quarter of the resolution of the second feature map. The resolution of the first feature map and the second feature map may be determined according to at least one of the requirements of speed or accuracy of feature extraction. For example, compared with extracting the feature maps of one sixteenth and one quarter of the resolution of the image to be matched, the operation of extracting the feature maps of one eighth and one half of the resolution of the image to be matched is slower but higher in accuracy, and the operation of extracting the feature maps of one sixteenth and one quarter of the resolution of the image to be matched is faster but lower in accuracy. In the embodiment of the present disclosure, the first local feature included in the first feature map and the second local feature included in the second feature map, which are acquired according to the pyramid convolution neural network, do not have the global receptive field of the image to be matched.

Herein, before the first local features are transformed into the first transformation feature having the global receptive field of the image to be matched, the method further includes at least one of the following steps: one is that the corresponding position information of the first local feature in the image to be matched is added to the first local feature. Specifically, by using position coding, each first local feature is provided with a unique position information identifier by means of position coding. Herein, P_{x,y}⁽ⁱ⁾ subjected to position coding may be denoted as:

$${P}_{x , y}^{( i )} = {f ( x , y )}^{( i )} = \{ \begin{matrix}sin ( {w}_{k} * x ) , if i = 4 k \\ cos ( {w}_{k} * x ) , if i = 4 k + 1 \\ sin ( {w}_{k} * y ) , if i = 4 k + 2 \\ cos ( {w}_{k} * y ) , if i = 4 k + 3\end{matrix}$$

Herein,

$${w}_{k} = \frac{1}{1000 {0}^{2 k / d}} \cdot {P}_{x , y}^{( i )}$$

denotes a pixel coordinate of the ith first local feature, and k denotes the grouping of the ith first local feature in all the first local features. For example, when a first preset number of first local features are grouped, a second preset number of first local features are as a group, and knowing the dimension of the ith first local feature, a grouping position of the ith first local feature may be known. For example, there are a total of 256 first local features, and i=8, that is, the eighth first local feature is located in the second group (k=2) of all the first local features. d denotes a feature dimension before the first local feature is not position-coded.

The second one is that a plurality of first local features are transformed from a multi-dimensional arrangement to a one-dimensional arrangement. Specifically, the multi-dimensional arrangement may be two-dimensional, that is, the first local features forms a first feature map in the form of a two-dimensional matrix. The one-dimensional arrangement may be a way of converting the two-dimensional matrix into a one-dimensional sequence according to a certain order. By adding the corresponding position information of the first local feature in the image to be matched to the first local feature, the first transformation feature subjected to feature transformation can have the position information thereof in the image to be matched. In addition, a plurality of first local features are converted from a multi-dimensional arrangement to a one-dimensional arrangement, thus facilitating a transformation model to perform feature transformation on the first local features.

Compared with the operation of directly inputting the image to be matched to a transformation model, the operation of using the pyramid convolution neural network to extract the first feature map of the image to be matched first, and then inputting the first feature map into the transformation model can shorten the feature length inputting to the transformation model and therefore may reduce the computational cost.

In some embodiments, step S13 may specifically include the following steps: a first local feature is used as a first target feature, a first transformation feature is used as a second target feature, and each image to be matched is as a target range. The second target feature is obtained based on aggregation processing on the first target features within the same target range and/or aggregation processing on the first target features in different target ranges. Specifically, each target range is used as a current target range, and the following feature transformation is performed at least once on the current target range: one is that each first target feature within the current target range is used as a current target feature. The second one is that the current target feature within the current target range is aggregated with other first target features so as to obtain a third target feature corresponding to the current target feature. Herein, the step of aggregating the current target feature within the current target range with other first target features is performed by a self-attention layer in a transformation model. Herein, the manner of aggregating the features by the self-attention layer and the cross-attention layer may refer to a general art and will not be elaborated herein.

In some embodiments, a plurality of self-attention sublayers arranged in parallel are included in one self-attention layer, and all the first target features within each target range are input to the self-attention sublayers to perform aggregation on the first target features within the target range. That is, only the first target features within one target range are input to one self-attention sublayer, and the first target features of multiple target ranges cannot be input to the same self-attention sublayer simultaneously. Furthermore, the target features in a one-dimensional arrangement form are input to the self-attention sublayer. Aggregation processing is performed on the first target features through the self-attention layer, so that the obtained third target feature having a global receptive field of the image to be matched. The third one is that the third target feature within the current target range is aggregated with the third target features in other target ranges so as to obtain a fourth target feature corresponding to the current target feature. Herein, the step of aggregating the third target feature within the current target range with the third target features in other target ranges is performed by a cross-attention layer in the transformation model. Since the cross-attention layer has an asymmetric characteristic, an output result of the cross-attention layer only includes the output corresponding to one of the inputs. Therefore, the cross-attention layer also includes at least two cross-attention sublayers arranged in parallel, and the third target feature within the current target range and the third target features in other target ranges are simultaneously input to the parallel cross-attention sublayers. Of course, during the process, the order of inputting the third target feature within the current target range and the third target features in other target ranges to the cross-attention sublayers needs to be exchanged. For example, in the first cross-attention sublayer, the third target feature within the current target range is used as a left input and the third target features in other target ranges are used as a right input. While in the second cross-attention sublayer, the third target feature within the current target range is used as a right input, and the third target features in other target ranges are used as a left input. The fourth target feature is acquired through two parallel cross-attention sublayers, so that the third target feature corresponding to each target range has a corresponding fourth target feature. Optionally, one self-attention layer and one cross-attention layer are used as one basic transformation. A plurality of basic transformations are included in the transformation model, and learnable network weights included in each basic transformation are not sharing. Moreover, the number of basic transformations may be determined according to the feature transformation accuracy and the feature transformation speed. For example, if a high accuracy of the feature transformation is required, the number of basic transformations may be relatively increased. If a high speed of the feature transformation is required, the number of basic transformations may be correspondingly decreased. Therefore, the number of basic transformations is not specified here. Herein, in the case where the current feature transformation is not the last feature transformation, the fourth target feature is used as the first target feature in the next feature transformation. Herein, in the case where the current feature transformation is the last feature transformation, the fourth target feature is used as the second target feature in the fourth feature transformation. That is, the output result of the previous basic transformation will be the input of the subsequent basic transformation. The result of the last basic transformation is taken as the second target feature.

The feature of a high-resolution feature map is extracted and transformed into a feature having the global receptive field of the feature block, and then feature matching is performed using the feature, so that the global information can be comprehensively considered during the matching process, and the feature matching result is more accurate.

In some embodiments, the first target features within the current target range are aggregated so that the third target feature can have global information about the current target range, and the third target features of different target ranges are aggregated so that the fourth target feature can have global information about other target ranges. Moreover, the finally obtained second target feature is made more accurate through at least once of such feature transformation, so that when the second target feature is used to perform feature matching, a more accurate feature matching result can be acquired.

In some embodiments, the mechanism used in at least one of the self-attention layer or the cross-attention layer is a linear attention mechanism. Specifically, a kernel function used in the self-attention layer and the cross-attention layer may be any kernel function, and the kernel function is rewritten as the product of two mapping functions by reversely using kernel skill. Then, the computational order of the attention layer is changed by using the combination rate of matrix multiplication, and the complexity is reduced from traditional square complexity to linear complexity. Herein, the mapping function φ (x) may be elu (x)+1. Specifically, the conventional attention layer calculation is Attention (Q, K, V)=Softmax (QKT) V, where Q is usually named query, K is usually named key, V is usually named value, and T denotes transpose. The linear attention mechanism provided in the embodiment of the present disclosure may replace the kernel function Softmax (x1 x2) with the kernel function sim (x1, x2), and convert the kernel function sim (x1, x2) into the product of two mapping functions φ(x1) and φ(x2) of x1 and x2, thereby obtaining a linear attention layer Linear Attention (Q, K, V)=φ(Q) (φ(KT) V), and the specific process thereof is as follows:

Linear Attention(Q,K,V)=sim(Q,KT)V (1)

Sim(Q,K)=φ(Q)φ(KT) (2)

Φ(⋅)=elu(⋅)+1 (3)

Linear Attention(Q,K,V)=φ(Q)(φ(KT)V) (4)

In this way, the complexity in the feature transformation process can be made linear by using the linear attention mechanism, and the time required is less and the complexity is lower for the feature transformation compared with a non-linear attention mechanism.

Herein, the manner of obtaining a first matching result of the at least two images to be matched by matching the first transformation features in the at least two images to be matched includes the following steps. One is that a matching confidence coefficient between different first transformation features in the at least two images to be matched is acquired.

Optionally, the way of acquiring a matching confidence coefficient between different first transformation features in the at least two images to be matched includes the following steps. First, a similarity between different first transformation features in the at least two images to be matched is acquired. Specifically, the way of acquiring the similarity may be that the similarity between each two of all the first transformation features in the two images to be matched is calculated to form a similarity matrix. Herein, the way of calculating the similarity may be dot product similarity, cosine similarity, or other similarity measure methods with scale transformation. Secondly, the similarity is processed by using an optimal transportation mode to obtain the matching confidence coefficient between different first transformation features in the at least two images to be matched. Specifically, a similarity matrix is reversed as a cost matrix, and the cost matrix is subjected to a preset number of iterations of the Sinkhorn algorithm to obtain the matching confidence coefficient. That is, in this way, the solution of acquiring the matching confidence coefficient between different first transformation features in a image to be matched is converted into solving a discrete optimal transportation problem with entropy regularization. Herein, the selection of a preset number determines the convergence degree of the matching confidence coefficient, and the preset number may be selected according to specific requirements so as to implement a balance between accuracy and speed. Herein, the sum of each row and the sum of each column of the matrix formed by the obtained matching confidence coefficient are 1, respectively. In the embodiment of the disclosure, the images to be matched are referred to as a first image to be matched and a second image to be matched, respectively. Herein, the matching confidence coefficients of a certain row in a matching confidence matrix indicate the matching confidence coefficients between a certain first transformation feature in the first image to be matched and all the first transformation features in the second image to be matched. The matching confidence coefficients of a certain column in the matching confidence matrix indicate the matching confidence coefficients between a certain first transformation feature in the second image to be matched and all the first transformation features in the first image to be matched.

The second one is that a matching feature group in the at least two images to be matched is determined based on the matching confidence coefficient.

Herein, the matched first transformation features in the at least two images to be matched are the matching feature group. The matching feature group includes one respective first transformation feature in each image to be matched. That is, the matching feature group includes a respective first transformation feature in each of a plurality of images to be matched. Herein, the manner of determining, based on the matching confidence coefficient, the matching feature group in the at least two images to be matched may include forming the matching feature group by selecting the first transformation features whose matching confidence coefficient meets a matching condition from the at least two images to be matched. Optionally, the matching condition may include selecting the matching confidence coefficient which is the maximum both in the row and in the column in the matching confidence matrix. For example, if the confidence coefficient of the first row and the second column in the matching confidence matrix is the maximum both in the row and in the column, it means that the second local feature in the second image to be matched has the maximum confidence coefficient with the first transformation feature in the first image to be matched, and the first local feature in the first image to be matched has the maximum confidence coefficient with the second first transformation feature in the second image to be matched. The matching confidence coefficients between different first transformation features are acquired through the optimal transportation mode, and then the first transformation feature meeting the matching condition is selected from the matching confidence coefficients, so that the matching degree of the final matching feature group can meet the requirements. The third one is that a first matching result is obtained based on the matching feature group. Specifically, the first matching result is obtained based on the respective positions of the matching feature group in the at least two images to be matched. Herein, the respective positions of the matching feature group in the at least two images to be matched are first position, and the first matching result includes position information indicating the first position. Herein, the position information here may be the coordinates of the feature in the matching feature group in the image to be matched, but may also be the position coordinates of the feature in the first feature map, and the position coordinates may map the first position. By acquiring the matching confidence coefficient between different first transformation features and acquiring the matching feature group based on the matching confidence coefficient, the confidence coefficient of the finally obtained matching feature group is enabled to meet the requirements.

Herein, after obtaining the first matching result of the at least two images to be matched by matching the first transformation features in the at least two images to be matched, a matching block group is extracted from the second feature maps of the at least two images to be matched based on the first matching result. Herein, the matching block includes at least two feature blocks, and each feature block includes a plurality of second local features extracted from the second feature map of one image to be matched. Specifically, the manner of extracting, based on the first matching result, the matching block group from the second feature maps of the at least two images to be matched may include determining a corresponding second position of the first position in the second feature map. A feature block centered at the second position and of a preset size is extracted in the second feature map to obtain the matching block group. Herein, the number of feature blocks contained in the matching feature group depends on the number of the images to be matched. Optionally, the preset size here needs to meet the condition that the acquired matching block group only includes features in one pair of matching feature groups and does not include features in other matching feature groups. The feature block acquired through the first matching result includes the position of the matching feature group in the image to be matched, so that the second matching result obtained by performing feature matching on the feature block also has first position information. The second position is determined by the first position, and the feature block centered at the second position and of the preset size is extracted so as to reduce the probability of extracting an erroneous feature block.

In some embodiments, before obtaining a second matching result of the at least two images to be matched by matching the second transformation feature corresponding to the matching block group, the second local features in the feature block are transformed into a second transformation feature having a global receptive field of the feature block. Herein, the way of transforming the second local features in the feature block into the second transformation features having the global receptive field of the feature block may be that the second local feature is taken as a first target feature, the second transformation feature is used as a second target feature, and each feature block is used as a target range. The second target feature is obtained based on aggregation processing on the first target features within the same target range and/or aggregation processing on the first target features in different target ranges. Herein, the manner for specifically performing aggregation processing refers to the process of transforming the first local features into the first transformation feature having a global receptive field of a image to be matched. Herein, the transformation models used in the two processes may be the same and may also be different. When the two transformation models are different, the difference is that the number of basic transformations of this process is less than or equal to the number of basic transformations used in the process of transforming the first local features into the first transformation feature having the global receptive field of the image to be matched.

The feature of a high-resolution feature map is extracted and transformed into a feature having the global receptive field of the feature block, and then feature matching is performed by using the feature, so that the global information about the feature block can also be considered in the high-resolution feature matching process, and the feature matching result is more accurate.

The matching is performed on the second transformation feature corresponding to the matching block group to obtain a second matching result of the at least two images to be matched. Herein, the second transformation feature is the second local feature in the matching block group, or is obtained by transforming the second local feature in the matching block group. That is, the second transformation feature may be not subjected to feature transformation by a transformation module or may also be subjected to feature transformation by a transformation module, and no specific provision is made herein regarding the second transformation feature. The way of performing matching on the second transformation feature corresponding to the matching block group to obtain the second matching result of the at least two images to be matched may be that one feature block of the matching block group is used as a target block, and a second transformation feature at a preset position in the target block is used as a reference feature. The preset position may be the center of the target block. Since the center of the feature block is one feature of the matching feature group, using this feature as a reference feature makes the calculated matching relationship with each second transformation feature in other feature blocks more accurate. In other feature blocks of the matching block group, a second transformation feature matching the reference feature is searched. Specifically, the manner of searching the second transformation feature matching with the reference feature may be that the matching relationship between the reference feature and each of the second transformation features in other feature blocks is acquired. For example, the correlation operation is performed on the reference feature and the second transformation features in other feature blocks to obtain a thermodynamic diagram. Herein, thermodynamic values at different positions in the thermodynamic diagram indicate the matching degree between the reference feature and different second transformation features. The thermodynamic diagram is acquired, so that the matching degree between the reference feature and each second transformation feature in other feature blocks can be clearly indicated.

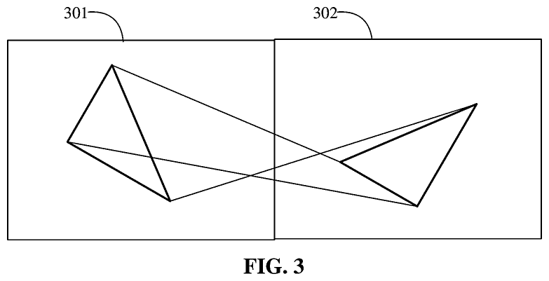

Based on the matching relationship, a second transformation feature matching the reference feature is found out from other feature blocks. Specifically, the thermodynamic diagram is processed by using a preset operator to obtain a second transformation feature matching the reference feature. Herein, the preset operator may be a Soft-Argmax operator. The second matching result is obtained based on the reference feature and the second transformation feature matching the reference feature. Specifically, a third position of the reference feature and the searched second transformation feature matching the reference feature in the at least two images to be matched is determined. Herein, the second matching result includes the third position of the reference feature and the searched second transformation feature matching the reference feature in the image to be matched and the matching degree therebetween. Of course, the third position may not be located at a pixel of the image to be matched and may be located in the middle of two pixels, and thus feature matching with sub-pixel accuracy can be implemented. The specific expression form of the second matching result may be presented in the form of a feature point pair, and may also be presented in the form of an image, referring to FIG. 3, FIG. 3 is a schematic diagram of a second matching result as illustrated in an embodiment of an image feature matching method according to the disclosure. As illustrated in FIG. 3, the left graph 301 is a first image to be matched and the right graph 302 is a second image to be matched. A connection line between the left graph 301 and the right graph 302 is used to indicate the matching result of the two images. The confidence coefficient may be presented by using line colors. For example, the confidence coefficient is represented using gradient ramp, or the respective confidence coefficient is directly marked near each line. The specific expression form of the second matching result is not specified here.

Feature matching in a low-resolution feature map is performed first, and then feature matching in a high-resolution feature map is performed by using a matching result of the low-resolution feature map, so that the matching accuracy is further improved.

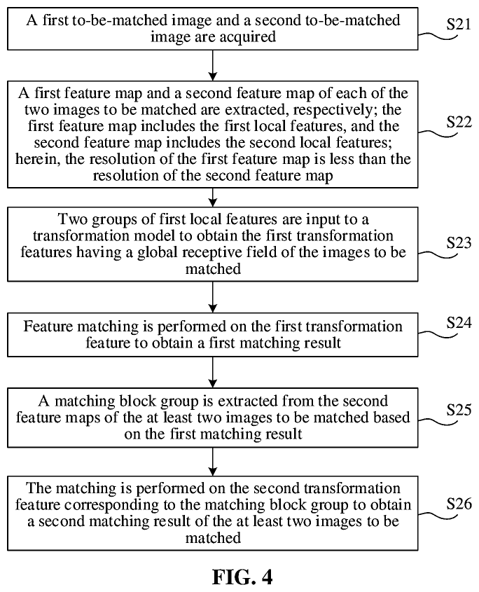

In order to more clearly describe the technical solutions proposed by the embodiments of the present disclosure, the following two examples are now provided for illustration. First Example: referring to FIG. 4, FIG. 4 is a second flowchart of an embodiment of an image feature matching method according to the disclosure. As illustrated in FIG. 4, the image feature matching method proposed by the embodiment of the present disclosure further includes the steps S21 to S26.

At S21, a first image to be matched and a second image to be matched are acquired.

Herein, the manner of acquiring the first image to be matched and the second image to be matched refers to S11 and is not elaborated here.

At S22, a first feature map and a second feature map of each of the two images to be matched are extracted, respectively. The first feature map includes the first local features, and the second feature map includes the second local features. Herein, the resolution of the first feature map is less than the resolution of the second feature map.

Herein, the manner of extracting the first feature map and the second feature map of the images to be matched may employ a pyramid convolution neural network. Reference may be made to the above-mentioned step S12 for details, and the description thereof will not be repeated here.

At S23, two groups of first local features are input to a transformation model to obtain the first transformation features having a global receptive field of the images to be matched.

Of course, before step S23 is performed, the first local features in the first feature map may be added to position coding and converted from the form of a two-dimensional matrix to the form of a one-dimensional sequence, and the first local feature group in the form of the one-dimensional sequence is input to the transformation model. The specific process of inputting the two groups of first local features into the transformation model to obtain the first transformation feature having a global receptive field of the images to be matched may refer to the above-mentioned step S13 and will not be repeated here.

At S24, feature matching is performed on the first transformation feature to obtain a first matching result.

The specific way of performing feature matching on the first transformation feature may refer to the above-mentioned step S14, and will not be elaborated herein.

At S25, a matching block group is extracted from the second feature maps of the at least two images to be matched based on the first matching result.

Herein, the process of extracting the matching block group from the second feature maps of the at least two images to be matched may refer to the above, and will not be elaborated herein.

At S26, the matching is performed on the second transformation feature corresponding to the matching block group to obtain a second matching result of the at least two images to be matched.

The specific way of matching the second transformation feature corresponding to the matching block group to obtain the second matching result of the at least two images to be matched may refer to the above, and will not be elaborated here.

Feature matching in a low-resolution feature map is performed first, and then feature matching in a high-resolution feature map is performed by using a matching result of the low-resolution feature map, so that the matching accuracy is further improved.

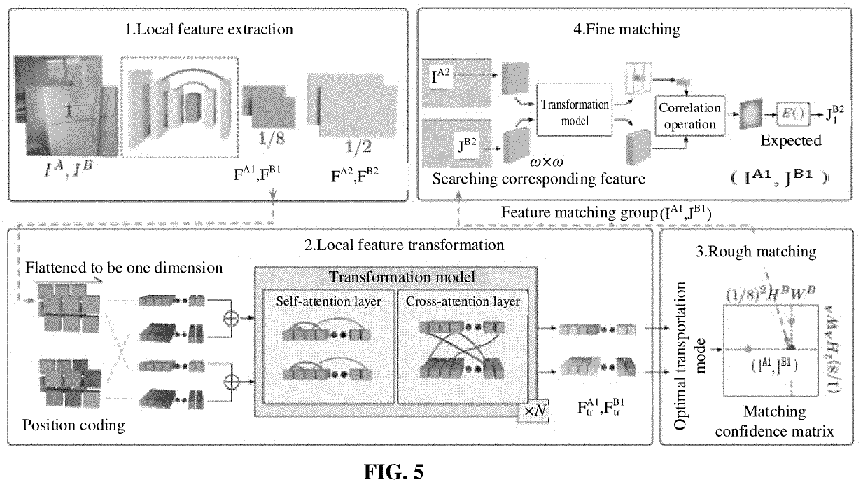

Second Example: referring to FIG. 5, FIG. 5 is a third flowchart of an embodiment of an image feature matching method according to the disclosure. As illustrated in FIG. 5, the image feature matching method provided in the embodiment of the disclosure may include the following steps.

1. Local Feature Extraction

A first image to be matched I^{A} and a second image to be matched I^{B} are acquired. Herein, the resolutions of the first image to be matched I^{A} and the second image to be matched I^{B} may be the same and may also be different. The first image to be matched I^{A} and the second image to be matched I^{B} are input to a pyramid convolution neural network to extract a multi-scale feature map. For example, the first feature maps F^{A1} and F^{B1} with a resolution of ⅛ of the resolution of the first image to be matched I^{A} and the second image to be matched I^{B} are extracted, respectively, and the second feature maps F^{A2} and F^{B2} with a resolution of ½ the resolution of the first image to be matched I^{A} and the second image to be matched I^{B} are extracted, respectively. It can be seen therefrom that the resolution of the first feature map F^{A1} is less than the resolution of the second feature map F^{A2}, and the resolution of the first feature map F^{B1} is less than the resolution of the second feature map F^{B2}.

2. Local Feature Transformation

In the embodiment of the present disclosure, a local feature image (i.e., the first feature map) may be transformed so as to enable the local feature image to have a global receptive field to facilitate subsequent global feature matching.

The features in the first feature maps F^{A1} and F^{B1} are position-coded, and the first feature maps F^{A1} and F^{B1} are flattened from two dimensions into a one-dimensional arrangement, i.e., a one-dimensional feature sequence. The one-dimensional feature sequences with position coding are input to a transformation model. In the transformation model, the one-dimensional feature sequences are first extracted by using a self-attention layer for feature aggregation. Then, the aggregated one-dimensional feature sequences are input to a cross-attention layer to perform feature aggregation on two groups of one-dimensional feature sequences. One layer of the self-attention layer and one layer of the cross-attention layer are used as a basic transformation. There are N of such basic transformations. An output of the previous basic transformation is used as an input of the subsequent basic transformation, an output result of the last basic transformation is used as an output result of the transformation model, and the output result includes one-dimensional feature sequences Fₜᵣ^{A1}, Fₜᵣ^{B1}. Specifically, the self-attention layer and the cross-attention layer perform feature aggregation by extracting the positions of features and local features that are context-dependent of the features.

3. Coarse Matching

A matching confidence matrix between the one-dimensional feature sequences Fₜᵣ^{A1} and Fₜᵣ^{B1} is obtained by using an optimal transportation mode. Herein, the length of the matching confidence matrix is equal to (⅛)² times the product of the length and width of the second image to be matched I^{B} (i.e., (⅛)²H^{B}W^{B}), and the width of the matching confidence matrix is equal to (⅛)² times the product of the length and width of the first image to be matched I^{A} (i.e., (⅛)²H^{A}W^{A}). The feature matching group (I^{A1}, J^{B1}) whose confidence coefficient meets the conditions is selected from the matching confidence coefficients. Herein, the feature matching group is not limited to one group, but can be multiple groups.

4. Fine Matching

Features (I^{A2}, J^{B2}) corresponding to the feature matching groups (I^{A1}, J^{B1}) are found out from the second feature maps F^{A2} and F^{B2}, and the feature block group including the feature I^{A2} or feature J^{B2} are extracted. Herein, the length and width of the feature blocks in the feature block group are W. The feature block group is input to another transformation model to obtain an aggregated feature map. Herein, the transformation model here and the transformation model in local feature transformation may be the same and may also be different. For example, the number of basic transformations in the transformation model herein may be less than the number of basic transformations of the transformation model in the local feature transformation. The feature I^{A2} of a center position of one feature block is used as a reference feature and is subjected to correlation operation with all features in another feature block to obtain a thermodynamic diagram, and the thermodynamic diagram is input into a two-dimensional Soft-Argmax operator to calculate an expected matching position J₁^{B2} in the feature block. I^{A2} and J₁^{B2} matching I^{A2} are projected onto the first image to be matched I^{A} and the second image to be matched I^{B} to obtain a final feature matching result of the first image to be matched.

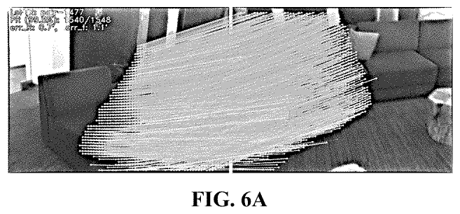

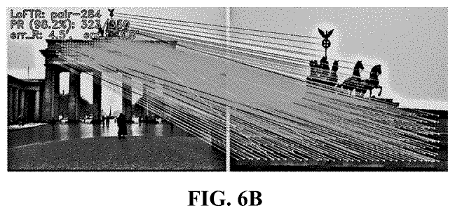

Exemplarily, the image feature matching method provided by the embodiment of the present disclosure may perform matching on indoor images as well as on outdoor images. FIG. 6A illustrates a schematic diagram of an exemplary indoor image feature matching result. FIG. 6B illustrates a schematic diagram of an exemplary outdoor image feature matching result. It is to be seen from FIG. 6A and FIG. 6B that the image feature matching method provided by the embodiment of the present disclosure may accurately match the same content in the images.

Through the above solution, the feature having the global receptive field in the image to be matched is acquired and then feature matching is performed by using the feature having the global receptive field, so that the global information about the image to be matched can be considered in the feature matching process, thus improving the matching accuracy.

In some embodiments, the technical solution provided by the embodiment of the disclosure does not need feature detection, which reduces the influence of the accuracy of feature detection on feature matching, and makes the solution more universal.

Herein, the technical solution provided by the embodiment of the present disclosure may implement dense feature matching of the two images to be matched. The solution may be integrated into Visual Simultaneous Localization And Mapping (V-SLAM). The present method provides accurate dense matching, which is advantageous for the visual positioning and map building. The characteristics of high efficiency and easy balancing of accuracy-speed of the solution facilitate coordination between simultaneous positioning and map building of modules. Moreover, the solution has high robustness, which makes V-SLAM run stably in any scenario under different climatic conditions, for example, indoor navigation, unmanned driving and other fields. Moreover, the solution may be used for three-dimensional reconstruction, and accurate dense matching provided by the solution facilitates reconstruction of fine object and scenario models, for example providing vision-based three-dimensional reconstruction of human body and objects for users. Of course, the solution may also be used for image registration, and the accurate dense matching provided by the solution facilitates solving the transformation model between a source image and a target image. For example, the solution is applied to mobile phones for image mosaic to implement panoramic photography, or the solution is embedded into a medical imaging system for image registration, so that doctors can conduct analysis or surgery according to a registration result.

It is to be understood by those skilled in the art that, in the above-mentioned method of the specific implementations, the writing sequence of each step does not mean a strict execution sequence and is not intended to form any limitation to the implementation process, and a specific execution sequence of each step should be determined by functions and probable internal logic thereof.

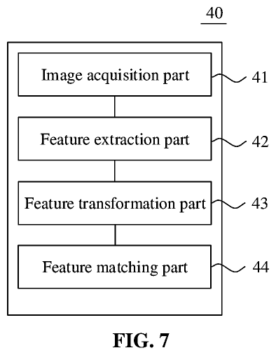

Referring to FIG. 7, FIG. 7 is a structural schematic diagram of an embodiment of an image feature matching apparatus according to the disclosure. The image feature matching apparatus 40 includes an image acquisition part 41, a feature extraction part 42, a feature transformation part 43 and a feature matching part 44. The image acquisition part 41 is configured to acquire at least two images to be matched. The feature extraction part 42 is configured to obtain a feature representation of each image to be matched by performing feature extraction on the image to be matched, herein the feature representation includes a plurality of first local features. The feature transformation part 43 is configured to transform the first local features into first transformation features having a global receptive field of the images to be matched. The feature matching part 44 is configured to obtain a first matching result of the at least two images to be matched by matching first transformation features in the at least two images to be matched.

Through the above solution, the feature having the global receptive field in the image to be matched is acquired and then feature matching is performed by using the feature having the global receptive field, so that the global information about the image to be matched can be considered during the feature matching process, thus improving the matching accuracy.

In some embodiments, the feature representation includes a first feature map and a second feature map. The resolution of the first feature map is less than the resolution of the second feature map. The features in the first feature map are the first local features, and the features in the second feature map are the second local features. After obtaining the first matching result of the at least two images to be matched by matching the first transformation features in the at least two images to be matched, the feature matching part 44 is further configured to: extract a matching block group from second feature maps of the at least two images to be matched based on the first matching result, herein the matching block group includes at least two feature blocks, and each feature block includes a plurality of second local features extracted from the second feature map of a respective image to be matched; and obtain a second matching result of the at least two images to be matched by matching second transformation features corresponding to the matching block group, herein a second transformation feature is the respective second local features in the matching block group or is obtained by transforming the respective second local features in the matching block group.

Through the above solution, feature matching in a low-resolution feature map is performed first, and then feature matching in a high-resolution feature map is performed by using a matching result of the low-resolution feature map, so that the matching accuracy is further improved.

In some embodiments, before obtaining the second matching result of the at least two images to be matched by matching the second transformation features corresponding to the matching block group, the feature transformation part 43 is further configured to: transform the second local features in the feature block into the second transformation features having a global receptive field of the feature block.

Through the above solution, the feature of a high-resolution feature map is extracted and transformed into a feature having the global receptive field of the feature block, and then feature matching is performed by using the feature, so that the global information about the feature block can also be considered during the high-resolution feature matching process, and the feature matching result is more accurate.

In some embodiments, the feature transformation part 43 is specifically configured to use the first local feature as a first target feature, the first transformation feature as a second target feature, and each image to be matched as a target range; or use the second local feature as a first target feature, the second transformation feature as a second target feature, and each feature region as a target range; and obtain the second target feature by performing aggregation processing on the first target feature. Herein, the operation of performing aggregation processing on the first target feature includes at least one of: performing aggregation processing on the first target features within the same target range; or performing aggregation processing on the first target features in different target ranges.

Through the above solution, aggregation processing is performed on the target features within the same target range, so that the second target feature is enabled to have a global receptive field of the target range, and/or aggregation processing is performed on the first target features in different target ranges, so that the obtained second target feature is enabled to have a global receptive field of other target ranges.

In some embodiments, the feature transformation part 43 is specifically configured to: use each target range as a current target range, and perform the following feature transformations at least once on the current target range: each first target feature in the current target range is used as a current target feature; a third target feature corresponding to the current target feature is obtained by aggregating the current target feature within the current target range with other first target features; and a fourth target feature corresponding to the current target feature is obtained by aggregating the third target feature within the current target range with the third target features in other target ranges. Herein, in the case where the current feature transformation is not the last feature transformation, the fourth target feature is used as the first target feature in the next feature transformation. In the case where the current feature transformation is the last feature transformation, the fourth target feature is used as the second target feature.

Through the above solution, the first target features in the current target range are aggregated, the third target feature is obtained by aggregating the first target feature of the current target range, and the third target features of different target ranges are aggregated, so that the finally obtained second target feature not only has global information about the current target range but also has global information about other target ranges. Moreover, the finally obtained second target feature is made more accurate through at least once of such feature transformation, so that when the second target feature is used to perform feature matching, a more accurate feature matching result can be acquired.

In some embodiments, the step of aggregating the current target feature within the current target range with other first target features is performed by a self-attention layer in a transformation model. The step of aggregating the third target feature within the current target range with the third target features of other target ranges is performed by a cross-attention layer in the transformation model.

Through the above solution, the feature transformation is performed by using the self-attention layer and the cross-attention layer in the transformation model, so that acquiring a target feature having global receptive fields of the current target range and other target ranges can be implemented.

In some embodiments, the mechanism used in at least one of the self-attention layer or the cross-attention layer is a linear attention mechanism.

Through the above solution, the complexity in the feature transformation process can be made linear by using the linear attention mechanism, which requires less time and lower complexity for the feature transformation compared with a non-linear attention mechanism.

In some embodiments, the matching first transformation features in the at least two images to be matched are a matching feature group. The position of the matching feature group in the at least two images to be matched are first positions. The first matching result includes position information indicating the first position, and the corresponding region of the feature block in the image to be matched includes the first position.

Through the above solution, the feature block obtained by the first matching result contains the position of the matching feature group in the image to be matched. That is, the range for matching the second time is determined based on the position of the first matching result, so that the range for matching the second time can be selected more accurately, and then the features in the range are matched again, thereby further improving the matching accuracy.

In some embodiments, the feature matching part 44 is specifically configured to use one feature block of the matching block group as a target block, and use a second transformation feature at a preset position in the target block as a reference feature; search a second transformation feature matching the reference feature from other feature blocks of the matching block group; and obtain the second matching result based on the reference feature and the second transformation feature matching the reference feature.

Through the above solution, searching for a matching feature of the second transformation feature at the preset position in the target block without searching for a matching feature of each second transformation feature in the target block may reduce the complexity of searching for the matching feature and reducing the processing resources consumed in the feature matching process.

In some embodiments, the feature matching part 44 is specifically configured to: determine a corresponding second position of the first location in the second feature map; and obtain the matching block group by extracting the feature blocks, which are centered at the second position and have a preset size, in the second feature maps.

Through the above solution, the second position is determined through the first position, and the feature block centered at the second position and of the preset size is extracted so as to reduce the probability of extracting an erroneous feature block.

In some embodiments, the preset position is the center of the target block.

Through the above solution, since the center of the feature block is one feature of the matching feature group, using the feature as a reference feature makes the calculated matching relationship with each second transformation feature in other feature blocks more accurate.

In some embodiments, the feature matching part 44 is specifically configured to acquire a matching relationship between the reference feature and each second transformation feature in other feature blocks; and search, based on the matching relationship, the second transformation feature matching the reference feature from other feature blocks.

Through the above solution, the matching relationship between the reference feature and each second transformation feature in other feature blocks is acquired, so that feature matching of the reference feature may be implemented.

In some embodiments, the feature matching part 44 is specifically configured to obtain a thermodynamic diagram by performing correlation operation on the reference feature and each second transformation feature in the other feature blocks, herein the thermodynamic values at different positions in the thermodynamic diagram indicates the matching degree between the reference feature and different second transformation features. The operation of searching, based on the matching relationship, the second transformation feature matching the reference feature from other feature blocks includes: obtaining the second transformation feature matching the reference feature by processing the thermodynamic diagram by using a preset operator.

Through the above solution, the thermodynamic diagram is acquired, so that the matching degree between the reference feature and each second transformation feature in other feature blocks can be clearly indicated.

In some embodiments, the feature extraction part 42 is further configured to execute at least one of the following steps: adding corresponding position information of the first local feature in the image to be matched to the respective first local feature; or transforming the plurality of first local features from a multi-dimensional arrangement to a one-dimensional arrangement.

Through the above solution, by adding the corresponding position information of the first local feature in the image to be matched to the first local feature, the first transformation feature subjected to feature transformation can have the position information thereof in the image to be matched. In addition, a plurality of first local features are converted from a multi-dimensional arrangement to a one-dimensional arrangement, thus facilitating a transformation model to perform feature transformation on the first local features.

In some embodiments, the feature matching part 44 is specifically configured to: acquire a matching confidence coefficient between different first transformation features in the at least two images to be matched; determine a matching feature group in the at least two images to be matched based on the matching confidence coefficient, herein the matching feature group includes one respective first transformation feature in each image to be matched; and obtain the first matching result based on the matching feature group.

Through the above solution, by acquiring the matching confidence coefficient between different first transformation features and acquiring the matching feature group based on the matching confidence coefficient, the confidence coefficient of the finally obtained matching feature group is enabled to meet the requirements.

In some embodiments, the feature matching part 44 is specifically configured to: acquire a similarity between different first transformation features in the at least two images to be matched; and obtain the matching confidence coefficient between different first transformation features in the at least two images to be matched by processing the similarity by using an optimal transportation mode.

The feature matching part 44 is further configured to determine, based on the matching confidence coefficient, the matching feature group in the at least two images to be matched, which includes: forming the matching feature group by selecting first transformation features, whose matching confidence coefficient meets a matching condition, from the at least two images to be matched.

Through the above solution, the matching confidence coefficient between different first transformation features is acquired through the optimal transportation mode, and then the first transformation feature meeting the matching condition is selected from the matching confidence coefficient, so that the matching degree of the final matching feature group can meet the requirements.

Through the above solution, the feature having the global receptive field in the image to be matched is acquired and then feature matching is performed using the feature having the global receptive field, so that the global information about the image to be matched can be considered during the feature matching process, thus improving the matching accuracy.

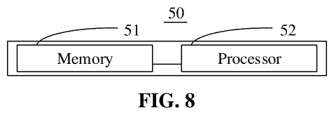

Referring to FIG. 8, FIG. 8 is a structural schematic diagram of an embodiment of an electronic device according to the disclosure. The electronic device 50 includes a memory 51 and a processor 52. The processor 52 is configured to execute a program instruction stored in the memory 51 to implement the steps in the image detection method embodiment. In a specific implementation scenario, the electronic device 50 may include, but is not limited to, a microcomputer and a server. In addition, the electronic device 50 may also include mobile devices, such as a notebook computer and a tablet computer, which are not limited herein.

Specifically, the processor 52 is configured to control the processor itself and the memory 51 to implement the steps in the image feature matching method embodiment. The processor 52 may also be referred to as a Central Processing Unit (CPU). The processor 52 may be an integrated circuit chip with signal processing capabilities. The processor 52 may also be a general-purpose processor, a Digital Signal Processor (DSP), an Application Specific Integrated Circuit (ASIC), a Field-Programmable Gate Array (FPGA) or other programmable logic devices, a discrete gate or transistor logic device, or a discrete hardware component. The general-purpose processor may be a microprocessor, or the processor may also be any conventional processor, etc. Furthermore, the processor 52 may be jointly implemented by the integrated circuit chip.

Through the above solution, the feature having the global receptive field in the image to be matched is acquired and then feature matching is performed using the feature having the global receptive field, so that the global information about the image to be matched can be considered during the feature matching process, thus improving the matching accuracy.

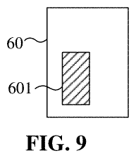

Referring to FIG. 9, FIG. 9 is a structural schematic diagram of an embodiment of a computer readable storage medium according to the disclosure. The computer readable storage medium 60 stores a program instruction 601 executable by a processor. The program instruction 601 is configured to implement the steps of the image feature matching method embodiment.

The embodiments of the disclosure further provide a computer program, which includes a computer readable code. The processor in the electronic device is configured to implement the steps of the image feature matching method embodiment when the computer readable code is running in the electronic device.

Through the above solution, the feature having the global receptive field in the image to be matched is acquired and then feature matching is performed using the feature having the global receptive field, so that the global information about the image to be matched can be considered during the feature matching process, thus improving the matching accuracy.

In some embodiments, the functions or parts of the apparatus provided by the embodiments of the disclosure can be used to execute the method described in the above method embodiments, and its specific implementation may refer to the description of the above method embodiment. For simplicity, it will not be elaborated herein.

The above descriptions of various embodiments tend to emphasize the differences between the various embodiments, and their similarities may be referred to each other. For simplicity, they are not elaborated herein.

In several embodiments provided by the disclosure, it is to be understood that the disclosed methods and devices may be implemented in other ways. For example, the apparatus embodiment described above is only schematic, and for example, division of the parts or units is only logic function division, and other division manners may be adopted during practical implementation. For example, units or components may be combined or integrated into another system, or some characteristics may be neglected or not executed. In addition, coupling or direct coupling or communication connection between each displayed or discussed component may be indirect coupling or communication connection, implemented through some interfaces, of the device or the units, and may be electrical and mechanical or adopt other forms.

In addition, functional units in the embodiments of the disclosure may be integrated into one processing unit, or each of the units may exist alone physically, or two or more units are integrated into one unit. The integrated unit may be implemented in a hardware form and may also be implemented in form of software functional unit.

When being implemented in form of software functional unit and sold or used as an independent product, the integrated unit may be stored in a computer-readable storage medium. Based on such an understanding, the technical solutions of the disclosure essentially, or the part contributing to the related art, or all or part of the technical solutions may be implemented in a form of a software product. The computer software product is stored in a storage medium and includes several instructions for instructing a computer device (which may be a personal computer, a server, or a network device) or a processor to perform all or some of the steps of the methods described in the embodiments of the disclosure. The above-mentioned storage medium includes: various media capable of storing program codes such as a U disk, a mobile hard disk, a Read-Only Memory (ROM), a Random Access Memory (RAM), a magnetic disk, or an optical disk.

1. A method for image feature matching, comprising:
acquiring at least two images to be matched;
obtaining a feature representation of each image to be matched by performing feature extraction on the image to be matched, wherein the feature representation comprises a plurality of first local features;
transforming the first local features into first transformation features having a global receptive field of the images to be matched; and
obtaining a first matching result of the at least two images to be matched by matching the first transformation features in the at least two images to be matched.

2. The method of claim 1, wherein the feature representation comprises a first feature map and a second feature map, a resolution of the first feature map is less than a resolution of the second feature map, features in the first feature map are the first local features, and features in the second feature map are second local features, and
wherein after obtaining the first matching result of the at least two images to be matched by matching the first transformation features in the at least two images to be matched, the method further comprises:
extracting a matching block group from second feature maps of the at least two images to be matched based on the first matching result, wherein the matching block group comprises at least two feature blocks, and each feature block comprises a plurality of second local features extracted from the second feature map of a respective image to be matched; and
obtaining a second matching result of the at least two images to be matched by matching second transformation features corresponding to the matching block group, wherein the second transformation features are the second local features in the matching block group or are obtained by transforming the second local features in the matching block group.

3. The method of claim 2, wherein before obtaining the second matching result of the at least two images to be matched by matching the second transformation features corresponding to the matching block group, the method further comprises:
transforming the second local features in the feature block into the second transformation features having a global receptive field of the feature block.

4. The method of claim 1, wherein transforming the first local features into the first transformation features having the global receptive field of the image to be matched, or transforming the second local features in the feature block into the second transformation features having the global receptive field of the feature block comprises:
using a first local feature as a first target feature, using a respective first transformation feature as a second target feature, and using each image to be matched as a target range; or using a second local feature as the first target feature, using a respective second transformation feature as the second target feature, and using each feature block as the target range; and
obtaining the second target feature by performing aggregation processing on first target features, wherein performing aggregation processing on the first target features comprises at least one of:
performing aggregation processing on the first target features within a same target range; or
performing aggregation processing on the first target features in different target ranges.

5. The method of claim 4, wherein obtaining the second target feature by performing aggregation processing on the first target features comprises:
using each target range as a current target range and performing following feature transformation at least once on the current target range:
using each first target feature in the current target range as a current target feature;
obtaining a third target feature corresponding to the current target feature by aggregating the current target feature within the current target range with other first target features; and
obtaining a fourth target feature corresponding to the current target feature by aggregating the third target feature within the current target range with the third target features in other target ranges,
wherein in a case where a current feature transformation is not a last feature transformation, the fourth target feature is used as the first target feature in a next feature transformation, and in a case where the current feature transformation is the last feature transformation, the fourth target feature is used as the second target feature.

6. The method of claim 5, wherein a step of aggregating the current target feature within the current target range with other first target features is performed by a self attention layer in a transformation model, and
a step of aggregating the third target feature within the current target range with the third target features in other target ranges is performed by a cross-attention layer in the transformation model.

7. The method of claim 6, wherein a mechanism used in at least one of the self-attention layer or the cross-attention layer is a linear attention mechanism.

8. The method of claim 2, wherein the matching first transformation features in the at least two images to be matched are a matching feature group, a position of the matching feature group in each of the at least two images to be matched is a first position, the first matching result comprises position information indicating the first position, and a corresponding region of the feature block in the image to be matched comprises the first position.

9. The method of claim 2, wherein obtaining the second matching result of the at least two images to be matched by matching the second transformation features corresponding to the matching block group comprises:
using one feature block of the matching block group as a target block, and using the second transformation feature at a preset position in the target block as a reference feature, wherein the preset position is a center of the target block;
searching, in other feature blocks of the matching block group, a second transformation feature matching the reference feature; and
obtaining the second matching result based on the reference feature and the second transformation feature matching the reference feature.

10. The method of claim 8, wherein extracting the matching block group from the second feature maps of the at least two images to be matched based on the first matching result comprises:
determining a corresponding second position of the first position in the second feature map; and
obtaining the matching block group by extracting the feature blocks, which are centered at the second position and have a preset size, in the second feature maps.

11. The method of claim 9, wherein searching, in other feature blocks of the matching block group, the second transformation feature matching the reference feature comprises:
acquiring a matching relationship between the reference feature and each second transformation feature in the other feature blocks; and
searching, based on the matching relationship, the second transformation feature matching the reference feature from the other feature blocks.

12. The method of claim 11, wherein acquiring the matching relationship between the reference feature and each second transformation feature in the other feature blocks comprises:
obtaining a thermodynamic diagram by performing correlation operation on the reference feature and each second transformation feature in the other feature blocks, wherein thermodynamic values at different positions in the thermodynamic diagram indicate matching degrees between the reference feature and different second transformation features; and
wherein searching, based on the matching relationship, the second transformation feature matching the reference feature from the other feature blocks comprises:
obtaining the second transformation feature matching the reference feature by processing the thermodynamic diagram by using a preset operator.

13. The method of claim 1, wherein before transforming the first local features into the first transformation features having the global receptive field of the image to be matched, the method further comprises at least one of following steps:
adding corresponding position information of the first local feature in the image to be matched to the respective first local feature, or
transforming the plurality of first local features from a multi-dimensional arrangement to a one-dimensional arrangement.

14. The method of claim 1, wherein obtaining the first matching result of the at least two images to be matched by matching the first transformation features in the at least two images to be matched comprises:
acquiring a matching confidence coefficient between different first transformation features in the at least two images to be matched;
determining, based on the matching confidence coefficient, a matching feature group in the at least two images to be matched, wherein the matching feature group comprises one respective first transformation feature in each image to be matched; and
obtaining the first matching result based on the matching feature group.

15. The method of claim 14, wherein acquiring the matching confidence coefficient between different first transformation features in the at least two images to be matched comprises:
acquiring a similarity between different first transformation features in the at least two images to be matched; and
obtaining the matching confidence coefficient between different first transformation features in the at least two images to be matched by processing the similarity by using an optimal transportation mode.

16. The method of claim 14, wherein determining, based on the matching confidence coefficient, the matching feature group in the at least two images to be matched comprises:
forming the matching feature group by selecting first transformation features, whose matching confidence coefficient meets a matching condition, from the at least two images to be matched.

17. An electronic device, comprising a memory and a processor, wherein the processor is configured to execute a program instruction stored in the memory so as to implement a method for image feature matching, wherein the method comprises:
acquiring at least two images to be matched;
obtaining a feature representation of each image to be matched by performing feature extraction on the image to be matched, wherein the feature representation comprises a plurality of first local features;
transforming the first local features into first transformation features having a global receptive field of the images to be matched; and
obtaining a first matching result of the at least two images to be matched by matching the first transformation features in the at least two images to be matched.

18. The electronic device of claim 17, wherein the feature representation comprises a first feature map and a second feature map, a resolution of the first feature map is less than a resolution of the second feature map, features in the first feature map are the first local features, and features in the second feature map are second local features, and
wherein after obtaining the first matching result of the at least two images to be matched by matching the first transformation features in the at least two images to be matched, the method further comprises:
extracting a matching block group from second feature maps of the at least two images to be matched based on the first matching result, wherein the matching block group comprises at least two feature blocks, and each feature block comprises a plurality of second local features extracted from the second feature map of a respective image to be matched; and
obtaining a second matching result of the at least two images to be matched by matching second transformation features corresponding to the matching block group, wherein the second transformation features are the second local features in the matching block group or are obtained by transforming the second local features in the matching block group.

19. The electronic device of claim 18, wherein before obtaining the second matching result of the at least two images to be matched by matching the second transformation features corresponding to the matching block group, the method further comprises:
transforming the second local features in the feature block into the second transformation features having a global receptive field of the feature block.

20. A non-transitory computer readable storage medium having stored thereon a program instruction which, when executed by a processor, implements a method for image feature matching, wherein the method comprises:
acquiring at least two images to be matched;
obtaining a feature representation of each image to be matched by performing feature extraction on the image to be matched, wherein the feature representation comprises a plurality of first local features;
transforming the first local features into first transformation features having a global receptive field of the images to be matched; and
obtaining a first matching result of the at least two images to be matched by matching the first transformation features in the at least two images to be matched.
